(19) United States
(12) Patent Application Publication
(10) Pub. No.: US 2026/0269733 A1
(43) Pub. Date: Sep. 10, 2026

(54) TWO-PHASE OPERATION OF THREE-PHASE MATRIX DUAL ACTIVE BRIDGE

(71) Applicant: SEMICONDUCTOR COMPONENTS INDUSTRIES, LLC, Scottsdale, AZ (US)

(72) Inventor: Daniel Leon GOLDMANN, Munich (DE)

(73) Assignee: SEMICONDUCTOR COMPONENTS INDUSTRIES, LLC, Scottsdale, AZ (US)

(21) Appl. No.: 19/534,974

(22) Filed: Feb. 10, 2026

Related U.S. Application Data
(60) Provisional application No. 63/768,659, filed on Mar. 7, 2025.
(60) Provisional application No. 63/768,632, filed on Mar. 7, 2025.
(60) Provisional application No. 63/768,601, filed on Mar. 7, 2025.

(51) Int. Cl. H02M 3/335; H02M 7/219

(52) U.S. Cl. CPC H02M 3/33573; H02M 7/219

(57) ABSTRACT

A power converter includes a transformer, an H-bridge coupled between a secondary side of the transformer and a battery, and a three-phase matrix bridge coupled between a three-phase AC voltage input and a primary side of the transformer, and a control circuit coupled to control switching of the three-phase matrix bridge and the H-bridge. The control circuit is configured to alternate between a selected two of a first two-phase switching pattern, a second two-phase switching pattern, and a third two-phase switching pattern, wherein (i) the first two-phase switching pattern comprises switching a first phase and a second phase of the three-phase matrix bridge, (ii) the second two-phase switching pattern comprises switching the first phase and a third phase of the three-phase matrix bridge, and (iii) the third two-phase switching pattern comprises switching the second phase and the third phase of the three-phase matrix bridge.

### PRIORITY

This application claims the benefit of U.S. Provisional Patent Application No. 63/768,601, filed March 7, 2025, U.S. Provisional Patent Application No. 63/768,632, filed March 7, 2025, and U.S. Provisional Patent Application No. 63/768,659, filed March 7, 2025, which are each hereby incorporated by reference herein in their entirety.

### TECHNICAL FIELD

The disclosure relates generally to power electronics, and in particular to a three-phase matrix dual active bridge power converter.

### BACKGROUND

Power electronics may be used to control the conversion and distribution of electric power. For example, switching power converters may be used to create a direct current (“DC”) voltage from an alternating current (“AC”) voltage by switching current through a magnetic element such as transformer. Conversely, inverters may be used to convert a DC voltage to an AC voltage.

Isolated power converters may be used in a broad range of applications, including for example as a battery charger for an electric vehicle. Conventional on-board battery chargers may include an AC-DC stage to rectify a low frequency AC voltage from the power grid to produce a DC voltage across an electrolytic bulk capacitor. An isolated DC-to-DC converter stage may in turn be used to transfer power from the electrolytic bulk capacitor to the battery. For example, a high-frequency inverter may convert the DC voltage at the bulk capacitor into a high-frequency AC signal for transfer from the primary side to the secondary side of an isolation transformer. A high-frequency rectifier stage may in turn be coupled to the secondary side of the transformer to convert the high-frequency AC signal to a DC signal for charging the battery. The transformer may provide galvanic isolation between the grid and the battery for safety purposes. In turn, the use of high-frequency switching across the transformer may allow for higher power density and smaller magnetic components, which may be important factors for on-board chargers.

The inventor of embodiments of the present disclosure has recognized that such conventional on-board battery chargers may require the use of bulky components, such as the electrolytic bulk capacitor, that may increase the cost and the physical space required for the on-board battery charger. Matrix converters have been described in the field as a means for converting the low-frequency AC grid voltage directly to a high-frequency AC signal for transfer across the isolation transformer. Such use of a matrix converter may thus eliminate the need for the aforementioned electrolytic bulk capacitor used to store the intermediate DC voltage. However, the inventor of embodiments of the present disclosure has also recognized that various matrix converter topologies may have significant drawbacks. For example, indirect matrix converter topologies may have limited power capability (for example, less than 1 kW) due to parasitic inductances. Further, soft-switching solid state transformer converters (S4T converters) may suffer from large DC currents and reflected voltages across the transformer due to the operation of the transformer as a flyback device. As another example, known three-phase matrix topologies may involve complex modulation schemes, allowing for only one discontinuous modulation scheme and thereby resulting in large peak currents through the high-frequency transformer. Further, the consumed grid current may be linearly dependent on the AC grid voltage, leading to only in phase sine currents being transferrable. Embodiments of the present disclosure may address one or more of these challenges.

### SUMMARY

The examples herein enable techniques for controlling the switching operation of a three-phase matrix dual active bridge converter.

According to one example, a power converter includes a transformer, an H-bridge coupled between a secondary side of the transformer and a battery, a three-phase matrix bridge coupled between a three-phase AC voltage input and a primary side of the transformer, and a control circuit coupled to control switching of the three-phase matrix bridge and the H-bridge, the control circuit configured to alternate between a selected two of a first two-phase switching pattern, a second two-phase switching pattern, and a third two-phase switching pattern, wherein the first two-phase switching pattern comprises switching a first phase and a second phase of the three-phase matrix bridge, the second two-phase switching pattern comprises switching the first phase and a third phase of the three-phase matrix bridge, the third two-phase switching pattern comprises switching the second phase and the third phase of the three-phase matrix bridge. In some embodiments, the first two-phase switching pattern further comprises disabling a third phase of the three-phase matrix bridge, the second two-phase switching pattern further comprises disabling the second phase of the three-phase matrix bridge, and the third two-phase switching pattern further comprises disabling the first phase of the three-phase matrix bridge. In the same or different embodiments, the control circuit is configured to determine the selected two of the first two-phase switching pattern, the second two-phase switching pattern, and the third two-phase switching pattern, based at least in part on a first phase voltage, a second phase voltage, and a third phase voltage at the three-phase AC voltage input. In the same or different embodiments, the control circuit is configured to change which two of the first, the second, and the third two-phase switching patterns comprise the selected two based at least in part on a change of the first phase voltage, the second phase voltage, and the third phase voltage at the three-phase AC voltage input. In the same or different embodiments, each of the first phase, the second phase, and the third phase of the three-phase matrix bridge comprises (i) a first bi-directional switch coupled between a first terminal of a primary winding of the transformer and a respective one of a first, a second, and a third AC voltage input, and (ii) a second bi-directional switch coupled between a second terminal of the primary winding of the transformer and the respective one of the first, the second, and the third AC voltage input. In the same or different embodiments, the H-bridge comprises a first switch coupled between a first terminal of a secondary winding of the transformer and a first terminal of the battery, a second switch coupled between the first terminal of the secondary winding of the transformer and a second terminal of the battery, a third switch coupled between a second terminal of the secondary winding of the transformer and the first terminal of the battery, and a fourth switch coupled between the second terminal of the secondary winding of the transformer and the second terminal of the battery. In the same or different embodiments, the power converter further comprises a three-phase filter coupled between the three-phase AC voltage input and the three-phase matrix bridge. In the same of different embodiments, the three-phase filter has a cut-off frequency lower than a frequency at which the control circuit is configured to alternate between the selected two of the first two-phase switching pattern, the second two-phase switching pattern, and the third two-phase switching pattern. In the same or different embodiments, the control circuit is configured to control switching of the three-phase matrix bridge and the H-bridge to regulate a flow of power from the three-phase AC voltage input to the battery. In the same or different embodiments, the control circuit is configured to control switching of the three-phase matrix bridge and the H-bridge to regulate a flow of power from the battery to the three-phase AC voltage input.

According to another embodiment, a power converter includes a transformer, an H-bridge coupled between a secondary side of the transformer and a battery, a three-phase matrix bridge coupled between a three-phase AC voltage input and a primary side of the transformer, and a control circuit coupled to control switching of the three-phase matrix bridge and the H-bridge, the control circuit configured to repeatedly alternate between a first two-phase switching pattern and a second two-phase switching pattern during a first macro-period, wherein (i) the first two-phase switching pattern comprises switching a first phase and a second phase of the three-phase matrix bridge during a first micro-period, and (ii) the second two-phase switching pattern comprises switching the first phase and a third phase of the three-phase matrix bridge during a second micro-period. In some embodiments, the first two-phase switching pattern further comprises disabling a third phase of the three-phase matrix bridge during the first micro-period, and the second two-phase switching pattern further comprises disabling the second phase of the three-phase matrix bridge during the second micro-period. In the same or different embodiments, the control circuit is configured to determine the first two-phase switching pattern and the second two-phase switching pattern based at least in part on a first phase voltage, a second phase voltage, and a third phase voltage at the three-phase AC voltage input. In the same or different embodiments, the control circuit is further configured to repeatedly alternate between a third two-phase switching pattern and a selected one of the first two-phase switching pattern and the second two-phase switching pattern during a second macro-period, wherein the third two-phase switching pattern comprises switching the second phase and the third phase of the three-phase matrix bridge while disabling the first phase of the three-phase matrix bridge. In the same or different embodiments, each of the first phase, the second phase, and the third phase of the three-phase matrix bridge comprises (i) a first bi-directional switch coupled between a first terminal of a primary winding of the transformer and a respective one of a first, a second, and a third AC voltage input, and (ii) a second bi-directional switch coupled between a second terminal of the primary winding of the transformer and the respective one of the first, the second, and the third AC voltage input. In the same or different embodiments, the H-bridge comprises a first switch coupled between a first terminal of a secondary winding of the transformer and a first terminal of the battery, a second switch coupled between the first terminal of the secondary winding of the transformer and a second terminal of the battery, a third switch coupled between a second terminal of the secondary winding of the transformer and the first terminal of the battery, and a fourth switch coupled between the second terminal of the secondary winding of the transformer and the second terminal of the battery. In the same or different embodiments, the power converter further comprises a three-phase filter coupled between the three-phase AC voltage input and the three-phase matrix bridge. In the same of different embodiments, the three-phase filter has a cut-off frequency lower than a frequency at which the control circuit is configured to alternate between the selected two of the first two-phase switching pattern, the second two-phase switching pattern, and the third two-phase switching pattern. In the same or different embodiments, the control circuit is configured to control switching of the three-phase matrix bridge and the H-bridge to regulate a flow of power from the three-phase AC voltage input to the battery. In the same or different embodiments, the control circuit is configured to control switching of the three-phase matrix bridge and the H-bridge to regulate a flow of power from the battery to the three-phase AC voltage input.

Another example provides a method for operating a power converter, wherein the method includes (i) receiving first, second, and third phase voltages at a respective first, second, and third phases of a three-phase matrix bridge coupled between a three-phase AC voltage input and a primary side of a transformer, (ii) selecting two of a first two-phase switching pattern, a second two-phase switching pattern, and a third two-phase switching pattern based at least in part on the first phase voltage, the second phase voltage, and the third phase voltage, wherein the first two-phase switching pattern comprises switching a first phase and a second phase of the three-phase matrix bridge, the second two-phase switching pattern comprises switching the first phase and the second phase of the three-phase matrix bridge, and the third two-phase switching pattern comprises switching the second phase and the third phase of the three-phase matrix bridge, (iii) switching the three-phase matrix bridge by applying, in an alternating fashion, the selected two of the first, the second, and the third two-phase switching pattern, (iv) switching an H-bridge coupled between a secondary side of the transformer and a battery. In some embodiments, the first two-phase switching pattern further comprises disabling a third phase of the three-phase matrix bridge, the second two-phase switching pattern further comprises disabling the second phase of the three-phase matrix bridge, and the third two-phase switching pattern further comprises disabling the first phase of the three-phase matrix bridge. In the same or different embodiments, the method further includes changing which two of the first two-phase switching pattern, the second two-phase switching pattern, and the third two-phase switching pattern comprise the selected two based at least in part on a change of the first phase voltage, the second phase voltage, and the third phase voltage. In the same or different embodiments, the method further includes filtering a three-phase current drawn from the three-phase AC voltage input. In the same or different embodiments, the method further includes regulating a flow of power from the three-phase AC voltage input to the battery based on the switching of the three-phase matrix bridge and the switching of the H-bridge. In the same or different embodiments, the method further includes regulating a flow of power from the battery to the three-phase AC voltage input based on the switching of the three-phase matrix bridge and the switching of the H-bridge.

### BRIEF DESCRIPTION OF THE DRAWINGS

A more complete understanding of the present embodiments may be acquired by referring to the following description taken in conjunction with the accompanying drawings, in which like reference numbers indicate like features.

FIG. 1 illustrates a schematic diagram of a power converter in accordance with embodiments of the present disclosure.

FIG. 2 illustrates a simplified schematic diagram of a power converter during a discrete period of operation in accordance with embodiments of the present disclosure.

FIG. 3A illustrates waveforms within a power converter in accordance with embodiments of the present disclosure.

FIG. 3B illustrates waveforms within a power converter in accordance with embodiments of the present disclosure.

FIG. 4 illustrates waveforms within a power converter in accordance with embodiments of the present disclosure.

FIG. 5A illustrates waveforms within a power converter in accordance with embodiments of the present disclosure.

FIG. 5B illustrates waveforms within a power converter in accordance with embodiments of the present disclosure.

FIG. 6A illustrates waveforms within a power converter in accordance with embodiments of the present disclosure.

FIG. 6B illustrates waveforms within a power converter in accordance with embodiments of the present disclosure.

FIG. 7 illustrates an example method of operating a power converter in accordance with embodiments of the present disclosure.

### DETAILED DESCRIPTION

Details of one or more embodiments are set forth in the description below and the accompanying drawings. Other features will be apparent from the description, drawings, and from the claims. The embodiments disclosed should not be interpreted, or otherwise used, as limiting the scope of the disclosure, including the claims. In addition, one skilled in the art understands that the following description has broad application, and the discussion of any embodiment is meant to be exemplary of that embodiment, and not intended to intimate that the scope of the disclosure, including the claims, is limited to that embodiment.

Various terms are used to refer to particular system components. Different companies may refer to a component by different names, and this disclosure does not intend to distinguish between components that differ in name but not form and function. In the following discussion and in the claims, the terms “including” and “comprising” are used in an open-ended fashion, and thus should be interpreted to mean “including, but not limited to.” Also, the term “couple” or “coupled” is intended to mean either an indirect or direct connection. Thus, if a first device couples to, or is coupled to, a second device, that connection between the first device and the second device may be through a direct connection or through an indirect connection via other devices and connections. As used herein, the term “and/or” includes any and all combinations of one or more of the associated listed items.

Further, although the terms “first,” “second,” “third,” and so forth may be used herein to describe various elements, these elements should not be limited by these terms. Terms such as “first,” “second,” and “third” may be used merely to distinguish one element from another. For example, a first element could be termed a second element, and, similarly, a second element could be termed a first element, without departing from the scope of the present disclosure. Further, the identification of a “first” element, does not necessarily require the presence of a “second” element.

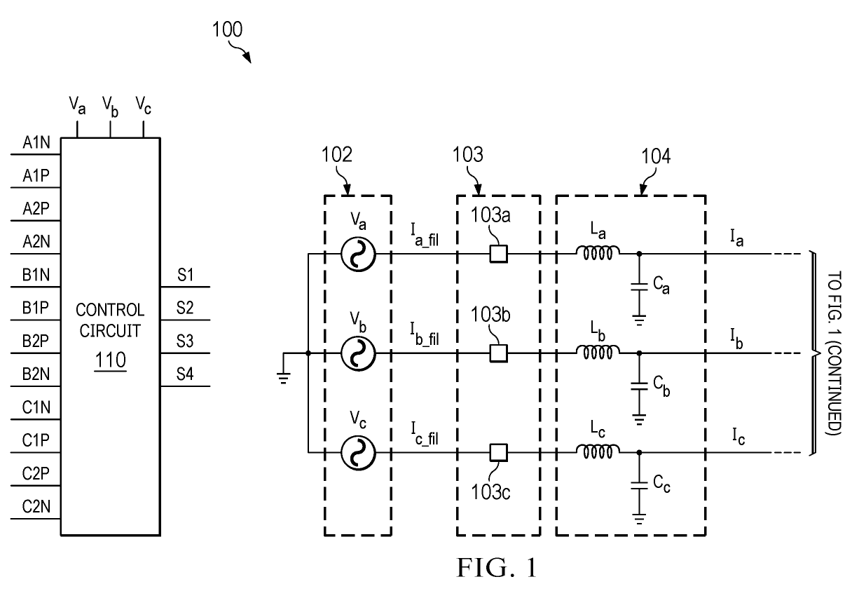

FIG. 1 illustrates a schematic diagram of power converter 100 in accordance with embodiments of the present disclosure. As shown in FIG. 1, power converter 100 may include three-phase AC voltage input 103, three-phase filter 104, control circuit 110, three-phase matrix bridge 120, inductance 155, transformer 160, and H-bridge 170. As shown in FIG. 1, three-phase matrix bridge 120 and H-bridge 170 may be coupled on opposing sides of transformer 160 and may be actively controlled by control circuit 110. Thus, for the purposes of the present disclosure, power converter 100 may also be referred to as a three-phase matrix dual active bridge converter. As described in further detail below, control circuit 110 may apply alternating two-phase switching patterns where only two of three line-to-line phases are active in a given micro-period, and whereby the selected active phases are alternated during alternating micro-periods. Such control may result in three line-to-neutral phase currents that can be individually controlled with their sum equaling zero. Accordingly, the phase current may be actively controlled for each two-phase combination and need not follow the line-to-line voltage. Power converter 100 may thus provide for balanced phase currents drawn from or provided to the grid even under conditions where the phase voltages supplied from the grid are unbalanced.

Three-phase AC voltage input 103 may be configured to receive a three-phase AC voltage from three-phase supply 102. In some embodiments, three-phase supply 102 may represent a three-phase grid supply. Three-phase AC voltage input 103 may be configured to receive a first phase voltage Va at a first AC voltage input 103a, to receive a second phase voltage Vb at a second AC voltage input 103b, and to receive a third phase voltage Vc at a third AC voltage input 103c.

Three-phase filter 104 may be coupled between three-phase AC voltage input 103 and three-phase matrix bridge 120. Three-phase filter 104 may be configured to filter the voltages provided by, and the currents drawn from or supplied to, three-phase supply 102. For example, three-phase filter 104 may include a first inductor Lₐ and a first capacitor Cₐ configured as an LC filter coupled between first AC voltage input 103a and a first phase 130 of three-phase matrix bridge 120, a second inductor L_{b} and a second capacitor C_{b} configured as an LC filter coupled between second AC voltage input 103b and a second phase 140 of three-phase matrix bridge 120, and a third inductor L_{c} and a third capacitor C_{c} configured as an LC filter coupled between third AC voltage input 103c and a third phase 150 of three-phase matrix bridge 120.

Three-phase matrix bridge 120 may be coupled between the three-phase AC voltage input 103 and the primary side of transformer 160. As shown in FIG. 1, three-phase matrix bridge 120 may be coupled to receive the three-phase AC voltage from three-phase AC voltage input 103 via three-phase filter 104. For example, three-phase matrix bridge 120 may include first phase 130, second phase 140, and third phase 150. First phase 130 may be coupled at node 121a to first AC voltage input 103a via three-phase filter 104. Second phase 140 may be coupled at node 121b to second AC voltage input 103b via three-phase filter 104. And third phase 150 may be coupled at node 121c to third AC voltage input 103c via three-phase filter 104.

As described directly below, each of the first phase 130, second phase 140, and third phase 150 may include a first bi-directional switch coupled between a first terminal 161 of a primary winding 160p of transformer 160 and a respective one of a first, a second, and a third AC voltage input, and may also include a second bi-directional switch coupled between a second terminal 162 of the primary winding 160p of transformer 160 and a respective one of the first, the second, and the third AC voltage input.

First phase 130 (also labeled as Phase A in FIG. 1) may include a first bi-directional switch 131 coupled in series with inductance 155 between first terminal 161 of primary winding 160p and node 121a, which in turn may be coupled via three-phase filter 104 to first AC voltage input 103a. First phase 130 may also include a second bi-directional switch 132 coupled between second terminal 162 of primary winding 160p and node 121a. In some embodiments, first bi-directional switch 131 may include a first transistor 131n coupled in series with a second transistor 131p, which may be driven at their respective gates by control signals A1N and A1P from control circuit 110. Similarly, second bi-directional switch 132 may include a first transistor 132n coupled in series with a second transistor 132p, which may be driven at their respective gates by control signals A2N and A2P from control circuit 110. As shown in FIG. 1, the respective first and second transistors of first bi-directional switch 131 and second bi-directional switch 132 may be coupled in series in a back-to-back configuration relative to each other (for example, with their respective sources coupled together) to block any unintended conduction path through the respective body diodes of those first and second transistors of first bi-directional switch 131 and second bi-directional switch 132.

Second phase 140 (also labeled as Phase B in FIG. 1) may include a first bi-directional switch 141 coupled in series with inductance 155 between first terminal 161 of primary winding 160p and node 121b, which in turn may be coupled via three-phase filter 104 to second AC voltage input 103b. Second phase 140 may also include a second bi-directional switch 142 coupled between second terminal 162 of primary winding 160p and node 121b. In some embodiments, first bi-directional switch 141 may include a first transistor 141n coupled in series with a second transistor 141p, which may be driven at their respective gates by control signals B1N and B1P from control circuit 110. Similarly, second bi-directional switch 142 may include a first transistor 142n coupled in series with a second transistor 142p, which may be driven at their respective gates by control signals B2N and B2P from control circuit 110. As shown in FIG. 1, the respective first and second transistors of first bi-directional switch 141 and second bi-directional switch 142 may be coupled in series in a back-to-back configuration relative to each other (for example, with their respective sources coupled together) to block any unintended conduction path through the respective body diodes of those first and second transistors of first bi-directional switch 141 and second bi-directional switch 142.

Third phase 150 (also labeled as Phase C in FIG. 1) may include a first bi-directional switch 151 coupled in series with inductance 155 between first terminal 161 of primary winding 160p and node 121c, which in turn may be coupled via three-phase filter 104 to third AC voltage input 103c. Third phase 150 may also include a second bi-directional switch 152 coupled between second terminal 162 of primary winding 160p and node 121c. In some embodiments, first bi-directional switch 151 may include a first transistor 151n coupled in series with a second transistor 151p, which may be driven at their respective gates by control signals C1N and C1P from control circuit 110. Similarly, second bi-directional switch 152 may include a first transistor 152n coupled in series with a second transistor 152p, which may be driven at their respective gates by control signals C2N and C2P from control circuit 110. As shown in FIG. 1, the respective first and second transistors of first bi-directional switch 151 and second bi-directional switch 152 may be coupled in series in a back-to-back configuration relative to each other (for example, with their respective sources coupled together) to block any unintended conduction path through the respective body diodes of those first and second transistors of first bi-directional switch 151 and second bi-directional switch 152.

H-bridge 170 may be coupled between a secondary side of transformer 160 and battery 180. For example, H-bridge 170 may include first switch 171, second switch 172, third switch 173, and fourth switch 174. First switch 171 may be coupled between a first terminal 163 of a secondary winding 160s of transformer 160 and a first terminal of battery 180. Second switch 172 may be coupled between the first terminal 163 of secondary winding 160s of transformer 160 and a second terminal of battery 180. Third switch 173 may be coupled between a second terminal 164 of secondary winding 160s of transformer 160 and the first terminal of battery 180. And fourth switch 174 may be coupled between the second terminal 164 of secondary winding 160s of transformer 160 and the second terminal of battery 180. As shown in FIG. 1, first switch 171, second switch 172, third switch 173, and fourth switch 174 may be coupled to be driven at their respective gates by respective control signals S1, S2, S3, and S4 from control circuit 110.

In some embodiments, such as shown in FIG. 1, the various switches that form three-phase matrix bridge 120 and H-bridge 170 may be implemented with for example, n-channel metal-oxide semiconductor field effect transistors (“n-channel MOSFETs” or “NMOS transistors”). In other embodiments, the various switches that form three-phase matrix bridge 120 and H-bridge 170 may be implemented with integrated-gate bi-polar transistors (“IGBTs”), or any other type of transistor suitable to handle the high voltages and currents of the application in which power converter 100 is implemented. In some embodiments, the various switches that form three-phase matrix bridge 120 and H-bridge 170 may be implemented with silicon carbide transistors, such as silicon carbide NMOS transistors or silicon carbide IGBTs. The various switches that form three-phase matrix bridge 120 and H-bridge 170 may also be formed by silicon transistors, or transistors formed on any other type of semiconductor substrate suitable to handle the high currents and high voltages of the application in which power converter 100 is implemented.

Control circuit 110 may be coupled to control switching of three-phase matrix bridge 120 and H-bridge 170. As shown in FIG. 1, control circuit 110 may output various control signals to control the switching on and off of the various transistors that form three-phase matrix bridge 120 and H-bridge 170. Specifically, control circuit 110 may be configured to control switching of three-phase matrix bridge 120 and H-bridge 170 to regulate a flow of power from three-phase AC voltage input 103 to the battery 180 that is coupled to H-bridge 170. For example, three-phase matrix bridge 120 may be controlled to convert a low-frequency AC input from three-phase supply 102 into a high-frequency AC signal that is transmitted across transformer 160 (from the primary side to the secondary side) and rectified by the controlled switching of H-bridge 170 to provide DC power to charge battery 180.

In some embodiments, power converter 100 may be configured as a bi-directional power converter. Accordingly, control circuit 110 may also be configured to control switching of three-phase matrix bridge 120 and H-bridge 170 to regulate a flow of power from battery 180 to three-phase AC voltage input 103. During such operation, control circuit 110 may control the switching of H-bridge 170 to convert the DC voltage across battery 180 into a high-frequency AC signal that is transmitted across transformer 160 (from the secondary side to the primary side). During such operation, control circuit 110 may also control the switching of three-phase matrix bridge 120 to convert the high-frequency AC signal from transformer 160 into a low-frequency AC signal that may be placed back on the grid via three-phase AC voltage input 103.

The inventor of embodiments of the present disclosure has recognized that the control scheme for controlling the switching of three-phase matrix bridge 120 and H-bridge 170 may be significantly simplified by time-division multiplexing the switching control provided by control circuit 110. For example, control circuit 110 may be configured to alternate between a selected two of (i) a first two-phase switching pattern, (ii) a second two-phase switching pattern, and (iii) a third two-phase switching pattern, over the course of a macro-period.

Each two-phase switching pattern may involve actively switching a selected two out of three phases of three-phase matrix bridge 120 while disabling the other of the three phases. For example, the first two-phase switching pattern may comprise switching a first phase (for example, first phase 130) and a second phase (for example, second phase 140) of the three-phase matrix bridge 120 while disabling the third phase (for example, third phase 150) of the three-phase matrix bridge 120. The second two-phase switching pattern may comprise switching the first phase (for example, first phase 130) and the third phase (for example, third phase 150) of the three-phase matrix bridge 120 while disabling the second phase (for example, second phase 140) of the three-phase matrix bridge 120. The third two-phase switching pattern may comprise switching the second phase (for example, second phase 140) and the third phase (for example, third phase 150) of the three-phase matrix bridge 120 while disabling the first phase (for example, first phase 130) of the three-phase matrix bridge 120.

Control circuit 110 may monitor the voltages received at three-phase AC voltage input 103 from three-phase supply 102. For example, as shown in FIG. 1, control circuit 110 may monitor each of Va, Vb, and Vc. In some embodiments, control circuit 110 may determine the selected two of the first two-phase switching pattern, the second two-phase switching pattern, and the third two-phase switching pattern based at least in part on a first phase voltage (Va for example), a second phase voltage (Vb for example), and a third phase voltage (Vc for example) present at the three-phase AC voltage input 103. Further, control circuit 110 may be configured to change which two of the first, the second, and the third two-phase switching patterns comprise the selected two based at least in part on a change of the first phase voltage (Va for example), the second phase voltage (Vb for example), and the third phase voltage (Vc for example) present at the three-phase AC voltage input 103.

For example, over a course of a first macro-period (for example, 60µs), control circuit 110 may repeatedly alternate between micro-periods (for example, 6µs each) of a first two-phase switching pattern and a second two-phase switching pattern. Subsequently, as the phase voltages (Va, Vb, and Vc) change over time, control circuit 110 may change which two-phase switching patterns are utilized. Thus, over the course of a second macro-period (for example, 60µs) subsequent to the first macro-period, control circuit may repeatedly alternate between micro-periods (for example, 6µs each) of a third two-phase switching pattern and a selected one of the first two-phase switching pattern and the second two-phase switching pattern utilized during the first macro-period.

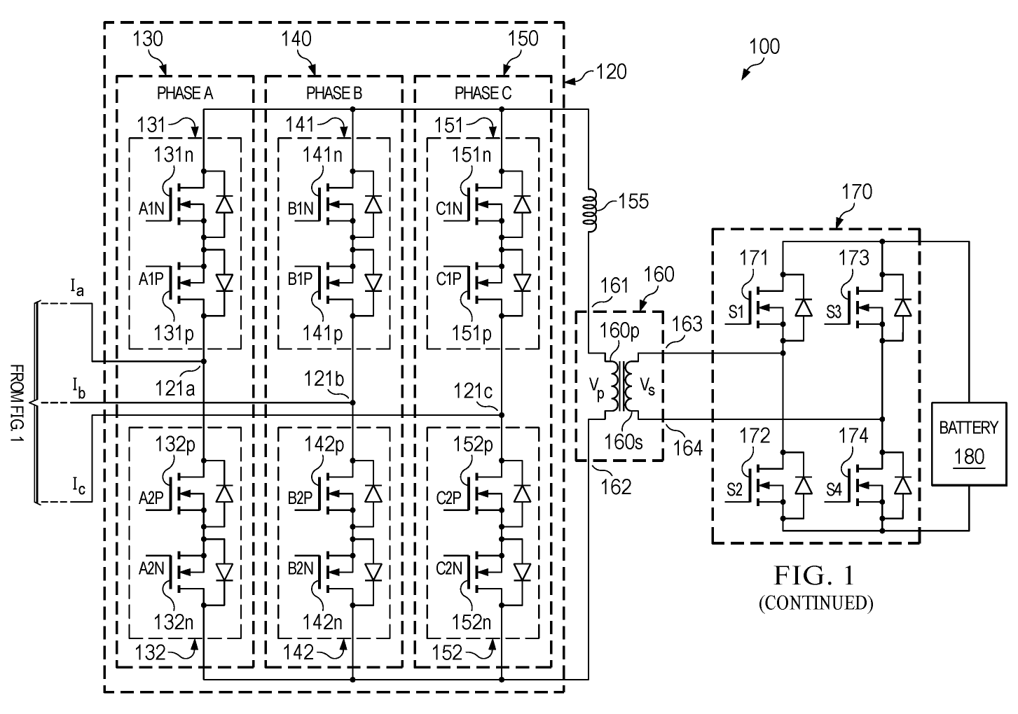

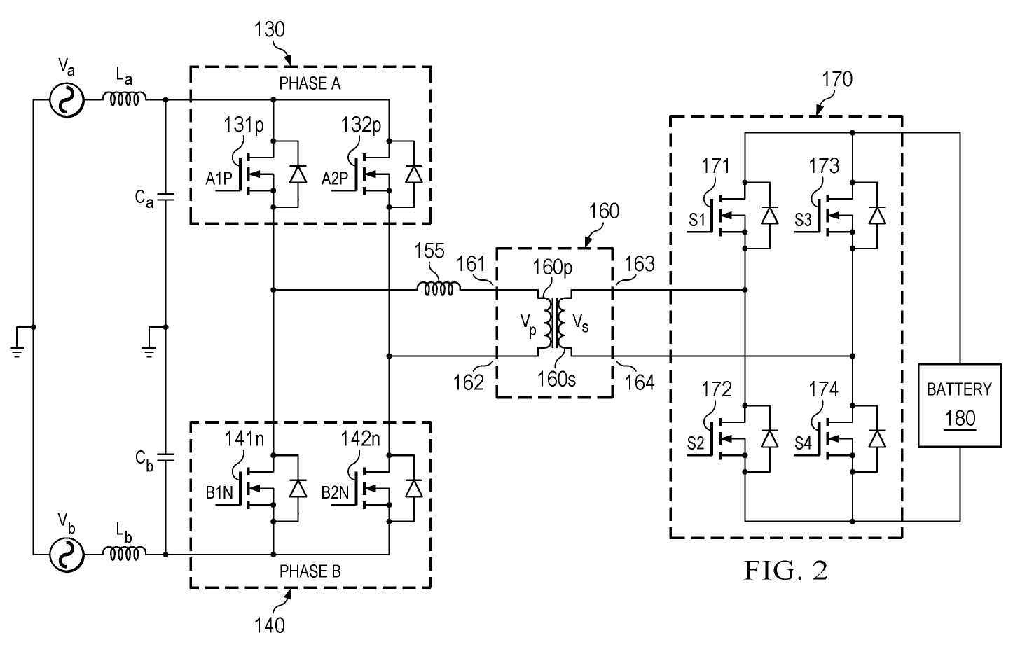

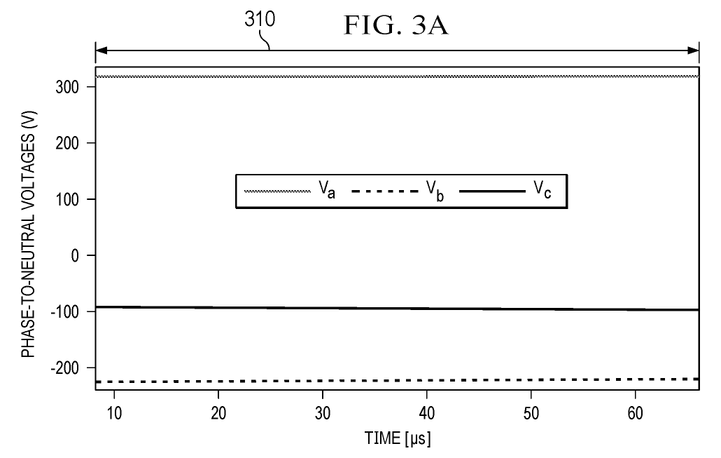

The three-phase AC voltage provided by three-phase supply 102 may have a low frequency of 50 Hz, for example. Given the low frequency, the three phase voltages (Va, Vb, and Vc) at three-phase AC voltage input 103 may have only a negligible change over the course of a macro-period and the repeated alternating micro-periods within any given macro-period. Accordingly, the control scheme for any given micro-period may be simplified as described below with reference to FIGS. 2, 3A, and 3B.

FIG. 2 illustrates a simplified schematic diagram of power converter 100 during a discrete period of operation in accordance with embodiments of the present disclosure. Specifically, FIG. 2 illustrates a simplified schematic diagram of power converter 100 during a first micro-period 311 within the macro-period 310 illustrated in FIG. 3A and FIG. 3B.

FIGS. 3A and 3B illustrate waveforms within power converter 100 in accordance with embodiments of the present disclosure. Specifically, FIG. 3A illustrates the levels of the first phase voltage Va, the second phase voltage Vb, and the third phase voltage Vc relative to neutral across macro-period 310. In turn, FIG. 3B illustrates the first phase-current Ia, the second phase current Ib, and the third phase current Ic, as control circuit 110 alternates between a first two-phase switching pattern during instances of micro-period 311 and a second two-phase switching pattern during the instances of micro-period 312 that are interleaved with the instances of micro-period 311.

As shown in illustrative example of FIG. 3A, Va may be roughly +310 Volts, Vb may be roughly -215 Volts, and Vc may be roughly -95 Volts throughout macro-period 310. And as indicated by FIG. 3B, control circuit 110 may repeatedly alternate between a first two-phase switching pattern and a second two-phase switching pattern over the course of macro-period 310. For example, control circuit 110 may control three-phase matrix bridge 120 according to a first two-phase switching pattern (switching first phase 130 and second phase 140 while disabling third phase 150) during repeated instances of first micro-period 311. Control circuit may also control three-phase matrix bridge 120 according to a second two-phase switching pattern (switching first phase 130 and third phase 150 while disabling second phase 140) during repeated instances of second micro-period 312 that are interleaved with the repeated instances of first micro-period 311.

When operating with a two-phase switching pattern of any given micro-period, the circuit analysis and corresponding control scheme may be simplified for that micro-period. For example, during each instance of micro-period 311 within macro-period 310, control circuit 110 may disable third phase 150 of three-phase matrix bridge 120 by driving each of first transistor 151n and second transistor 151p of first bi-directional switch 151, and first transistor 152n and second transistor 152p of second bi-directional switch 152, in respective off-states. Moreover, because Va is positive throughout micro-period 311, first transistor 131n of first bi-directional switch 131 and first transistor 132n of second bi-directional switch 132 within first phase 130 may be held in respective on-states throughout micro-period 311 to save switching losses as those transistors are not needed to selectively block or pass the positive voltage of Va during micro-period 311. Further, because Vb is negative throughout micro-period 311, second transistor 141p of first bi-directional switch 141 and second transistor 142p of second bi-directional switch 142 within second phase 140 may be held in respective on-states throughout micro-period 311 to save switching losses as those transistors are not needed to selectively block or pass the negative voltage of Vb during micro-period 311.

Under the above described conditions for the first two-phase switching pattern employed during micro-period 311, the schematic diagram of power converter 100 may be simplified as shown in FIG. 2. For example, the second transistors 131p and 132p of first phase 130 (also labeled as Phase A), combined with first transistors 141n and 142n of second phase 140 (also labeled as Phase B), may form a simple H-bridge for applying the differential of the first phase voltage Va and the second phase voltage Vb across the primary winding 160p of transformer 160 (and inductance 155). Although FIG. 2 illustrates a simplified schematic specific to the first two-phase switching pattern employed during micro-period 311, it is appreciated that the second two-phase switching pattern (employing first phase 130 and third phase 150 while disabling second phase 140) and the third two-phase switching pattern (employing second phase 140 and third phase 150 while disabling first phase 130) would result in simplified H-bridge configurations, similar to that shown in FIG. 2, for applying any selected two of Va, Vb, and Vc across the primary side of transformer 160.

As is appreciated in the art, the modulation schemes for such an H-bridge configuration at the primary side of a transformer in a dual active bridge converter may be less complex and more robust than modulation schemes for three-phase operation of a three-phase matrix bridge. Thus, the two-phase operation of three-phase matrix bridge 120 during any given micro-period may allow control circuit 110 to employ a broader range of modulation schemes for the selected two-phase switching pattern employed during that micro-period. For example, control circuit 110 may apply any of a triangular boost modulation scheme, a triangular buck modulation scheme, a trapezoidal modulation scheme, an extended phase shift modulation scheme, or a single phase shift modulation scheme, during a given micro-period, depending on status of the phase voltages and the current required by the application.

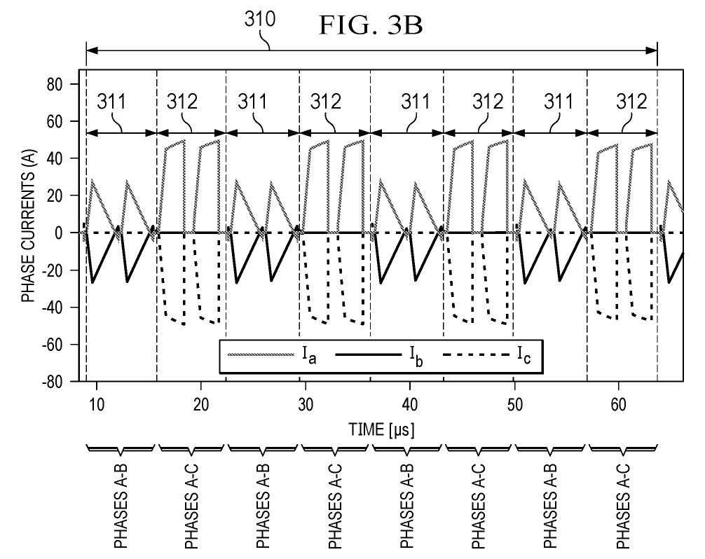

In some embodiments, the modulation scheme employed by the first two-phase switching pattern during instances of a first micro-period may be different than the modulation scheme employed by the second two-phase switching pattern during instances of a second micro-period that are interleaved with instances of the first micro-period. For example, as shown by the phase currents in FIG. 3B (and also by the primary winding current in FIG. 4), control circuit 110 may employ different modulation schemes for the alternating first two-phase switching pattern employed during instances of first micro-period 311 and the second two-phase switching pattern employed during instances of second micro-period 312. In the example illustrated in FIG. 3B (and also by the primary winding current in FIG. 4), control circuit 110 may control the switching of three-phase matrix bridge 120 and H-bridge 170 to employ a triangular modulation scheme with the first two-phase switching pattern during instances of first micro-period 311, and employ a trapezoidal modulation scheme with the second two-phase switching pattern during instances of second micro-period 312.

For the purposes of the present disclosure, a “two-phase switching pattern” may refer to which two of the three phases of three-phase matrix bridge may be employed during a given micro-period. The modulation scheme may in turn refer to the control of the on-times and off-times of the various switches within the selected two phases of the three-phase matrix bridge 120 in conjunction with the control of H-bridge 170, and the resulting shape of the currents that flow between the three-phase AC voltage input 103 and battery 180. The modulation schemes for first micro-period 311 and second micro-period 312 are described in further detail below with reference to FIG. 4 for example.

FIG. 4 illustrates waveforms within power converter 100 in accordance with embodiments of the present disclosure. Specifically, FIG. 4 illustrates the voltage (Vp) across the primary winding 160p of transformer 160, the voltage across the secondary winding 160s of transformer 160, and the primary winding current, as a result of the modulation schemes employed by the first two-phase switching pattern during instances of micro-period 311 and the second two-phase switching pattern during instances of micro-period 312.

During micro-period 311, control circuit 110 may drive first phase 130 and second phase 140 to apply Vp across the primary winding 160p, and may drive H-bridge 170 to apply Vs across secondary winding 160s. The magnitudes and pulse-widths of the voltages applied across the primary and secondary windings of transformer 160 may induce a triangular shaped current through inductance 155 and the primary winding 160p of transformer 160 during each instance of micro-period 311. During micro-period 312, control circuit 110 may drive first phase 130 and third phase 150 to apply Vp across the primary winding 160p, and may drive H-bridge 170 to apply Vs across secondary winding 160s. The magnitudes and pulse-widths of the voltages applied across the primary and secondary windings of transformer 160 may induce a trapezoidal shaped current through inductance 155 and the primary winding 160p of transformer 160 during each instance of micro-period 312.

In some embodiments, the modulation scheme employed by each of the selected two of the first, second, and third two-phase switching patterns may be determined based in part on the level of the corresponding phase voltages (Va, Vb, and Vc) across a given macro-period and the alternating micro-periods therein. For example, the pulse-widths of the voltages applied across the primary winding and the secondary winding (and the currents induced as a result thereof) for each micro-period may be controlled based on the corresponding two phase voltages (the corresponding two of Va, Vb, and Vc) for that micro-period. The modulation scheme for each micro-period may thus be optimized for the specific line to line voltage and current for the corresponding phases. Moreover, as shown in FIG. 4, short breaks may be included between the two modes of the alternating two-phase switching patterns. This may allow time for a change from one set of active phases to another set of active phases, and may also prevent the accumulation of flux in the transformer core.

As described above with reference to FIGS. 3A and 3B, the selection of the two out of the three possible two-phase switching patterns may be determined based in part on the phase voltages (Va, Vb, and Vc). In some embodiments, the phase requesting the most current may be operated continuously while the other two phases are discontinuous (thereby keeping transformer RMS current low). For example, during the macro-period 310 shown in FIGS. 3A and 3B, the first phase voltage Va may have a higher magnitude than the second phase voltage Vb and the third phase voltage Vc. To maintain a high power factor (with the respective phase currents linearly tracking the respective phase voltage), control circuit 110 may select the first and second two-phase switching patterns to alternate between during macro-period 310. Accordingly, the first phase 130 (also labeled as Phase A) may be switched throughout macro-period 310, while the second phase 140 (also labeled as Phase B) and the third phase 150 (also labeled as Phase C) are alternatively enabled and disabled during repeating instances of micro-period 311 and micro-period 312. The average of the first phase current Iₐ may thus be controlled to be higher than the respective averages of the second phase current I_{b} and the third phase current I_{c} during macro-period 310, thereby more closely corresponding to the higher phase voltage Vₐ.

By operating the three-phase matrix bridge 120 according to the alternating two-phase switching patterns described herein, power converter 100 may individually set line-to-neutral currents for each of the first, second, and third phases, with their sum equaling zero. Accordingly, the transferred current for a given phase need not linearly track the AC voltage for that phase.

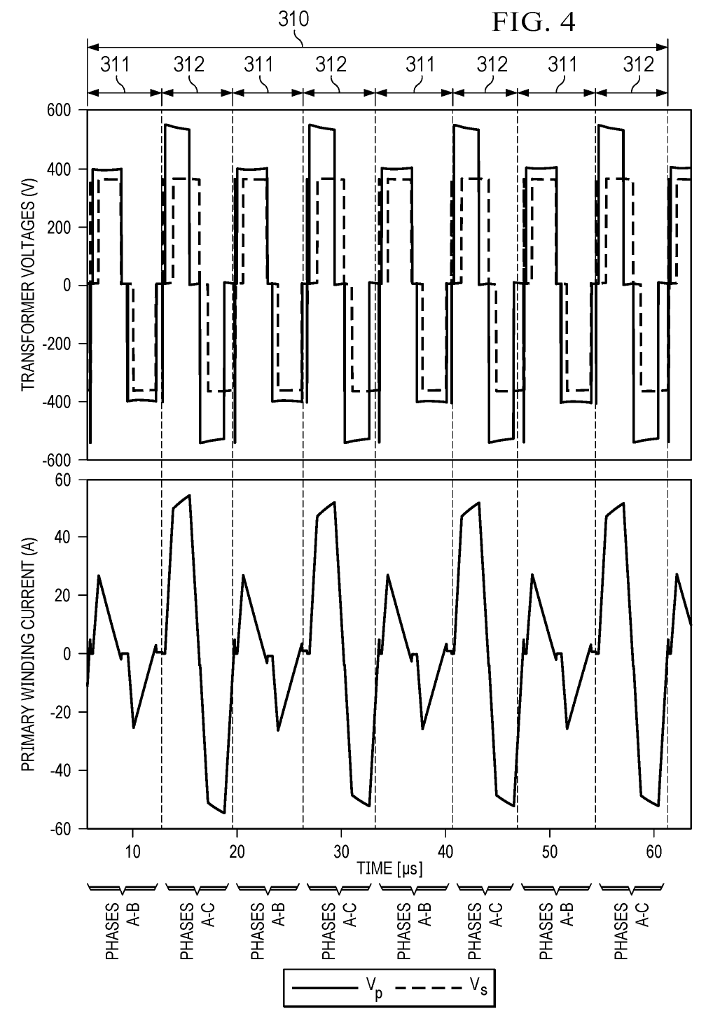

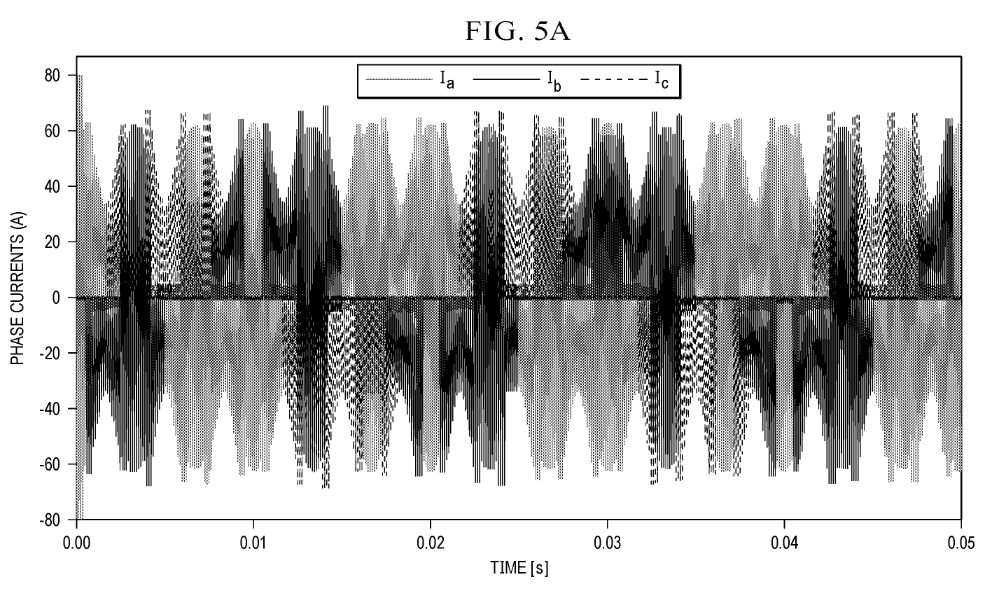

FIGS. 5A and 5B illustrate waveforms within power converter 100 in accordance with embodiments of the present disclosure. FIG. 5A illustrates the phase currents Iₐ, I_{b}, and I_{c} drawn by power converter 100 at the low-frequency AC side of three-phase matrix bridge 120 at a time scale corresponding to multiple cycles of first, second, and third phase voltages of three-phase supply 102. FIG. 5B illustrates the filtered phase currents I_{a_fil}, I_{b_fil}, and I_{c_fil} drawn by power converter 100 from three-phase AC voltage input 103 as filtered by three-phase filter 104.

As described above, by operating the three-phase matrix bridge 120 according to the alternating two-phase switching patterns described herein, power converter 100 may individually set line-to-neutral currents (corresponding to Iₐ, I_{b}, and I_{c}) for each of the first, second, and third phases, with their sum equaling zero. As the respective phase voltages vary up and down, the selected two of the three possible two-phase switching patterns may change across different macro-periods. Thus, the phase currents Iₐ, I_{b}, and I_{c} may be respectively controlled in a manner that is not necessarily sinusoidal and does not necessarily linearly track the corresponding phase voltages Va, Vb, and Vc during a given macro-period. Nonetheless, the respective averages of the phase currents Iₐ, I_{b}, and I_{c} may be controlled such that, when filtered by three-phase filter 104, those currents may have generally sinusoidal shapes that respectively track Va, Vb, and Vc. Three-phase filter 104 may have a cut-off frequency lower than a frequency at which control circuit 110 is configured to alternate between the selected two of the first two-phase switching pattern, the second two-phase switching pattern, and the third two-phase switching pattern. For example, in some embodiments, three-phase filter 104 may have a cut-off frequency of, for example 35 kHz. In other embodiments, the cut-off frequency of three-phase filter 104 may be any other frequency lower than the frequency at which control circuit 110 alternates between the selected two two-phase switching patterns. Accordingly, the respective averages of the phase currents Iₐ, I_{b}, and I_{c} may be controlled such that the filtered phase currents I_{a_fil}, I_{b_fil}, and I_{c_fil} may have generally sinusoidal shapes that respectively track the sinusoidal shapes of Va, Vb, and Vc. Power converter 100 may thus be operated with a high power factor if and where desired by the battery-charger application in which power converter 100 is implemented.

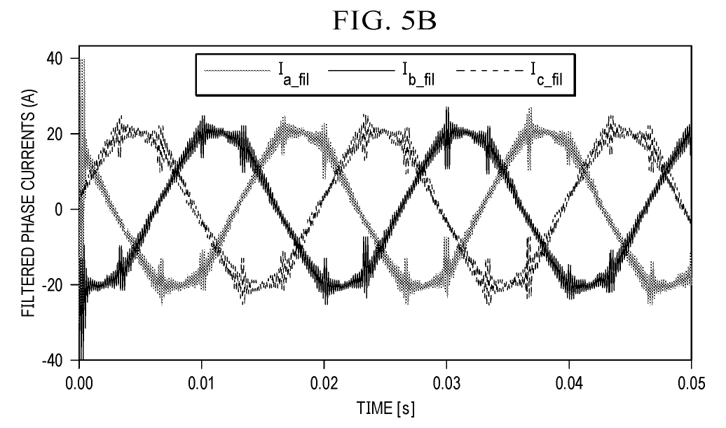

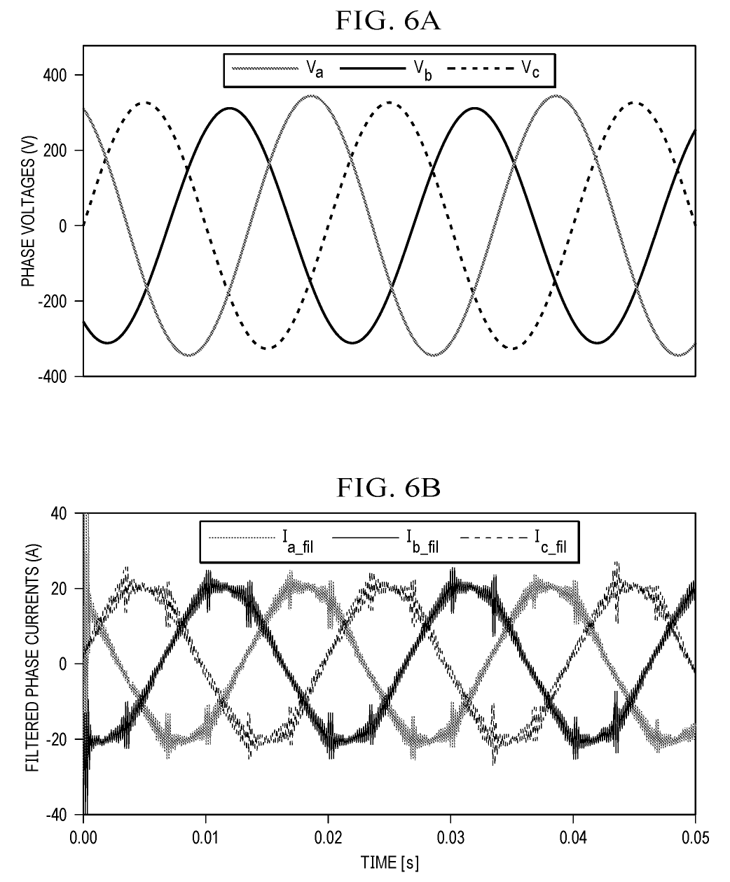

FIGS. 6A and 6B illustrate waveforms within power converter 100 in accordance with embodiments of the present disclosure. FIG. 6A illustrates a condition whereby the phase voltages Va, Vb, and Vc from three-phase supply 102 are unbalanced. FIG. 5B illustrates the filtered phase currents I_{a_fil}, I_{b_fil}, and I_{c_fil} drawn by power converter 100 from three-phase AC voltage input 103 as filtered by three-phase filter 104.

As described above, by operating the three-phase matrix bridge 120 according to the alternating two-phase switching patterns described herein, power converter 100 may individually set line-to-neutral currents (corresponding to Iₐ, I_{b}, and I_{c}) for each of the first, second, and third phases, with their sum equaling zero. As the respective phase voltages vary up and down, the selected two of the three possible two-phase switching patterns may change across different macro-periods. Thus, the phase currents Iₐ, I_{b}, and I_{c} may be respectively controlled in a manner that is not necessarily sinusoidal and does not necessarily linearly track the corresponding phase voltages Va, Vb, and Vc during a given macro-period. Nonetheless, as described above with reference to FIGS. 5A and 5B, the respective averages of the phase currents Iₐ, I_{b}, and I_{c} may be controlled such that the filtered phase currents I_{a_fil}, I_{b_fil}, and I_{c_fil} are in turn sinusoidal. However, because the underlying phase currents Ia, Ib, and Ic may be individually controlled and thereby decoupled from linearly tracking the line voltage, the underlying phase currents Iₐ, I_{b}, and I_{c} may be controlled such that the filtered phase currents I_{a_fil}, I_{b_fil}, and I_{c_fil} are sinusoidal and balanced even under conditions such as shown in FIG. 6A where the corresponding phase voltages Va, Vb, and Vc are unbalanced.

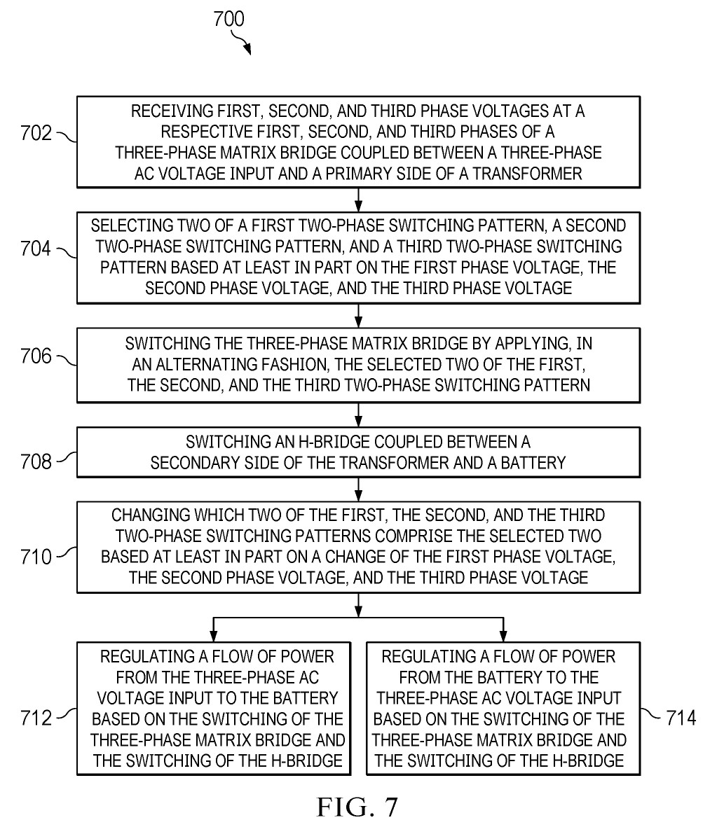

FIG. 7 illustrates an example method of operating a power converter in accordance with embodiments of the present disclosure. Method 700 may be performed by any suitable mechanism, such as control circuit 110 and/or power converter 100, and/or any suitable combination of the components included therein. Method 700 may be performed with fewer or more steps than shown in FIG. 7. Moreover, steps of method 700 may be omitted, repeated, performed in parallel, performed in a different order than shown in FIG. 7, or performed recursively. One or more steps of method 700, although shown in an order, may be performed at the same time or in a re-ordered manner.

Step 702 may include receiving first, second, and third phase voltages at a respective first, second, and third phases of a three-phase matrix bridge coupled between a three-phase AC voltage input and a primary side of a transformer. For example, as described above with reference to FIG. 1, three-phase matrix bridge 120 may be coupled to receive the three-phase AC voltage from three-phase AC voltage input 103 via three-phase filter 104. For example, three-phase matrix bridge 120 may include first phase 130, second phase 140, and third phase 150. First phase 130 may be coupled to receive first phase voltage Va via three-phase filter 104. Second phase 140 may be coupled to receive second phase voltage Vb via three-phase filter 104. And third phase 150 may be coupled to receive third phase voltage Vc via three-phase filter 104.

Step 704 may include selecting two of a first two-phase switching pattern, a second two-phase switching pattern, and a third two-phase switching pattern based at least in part on the first phase voltage, the second phase voltage, and the third phase voltage. For example, as described above with reference to FIG. 1, FIG. 2, and FIGS. 3A-3B, control circuit 110 may select two of a first two-phase switching pattern, a second two-phase switching pattern, and a third two-phase switching pattern to alternately apply during a macro-period (for example, 60µs). The first two-phase switching pattern may comprise switching a first phase (for example, first phase 130) and a second phase (for example, second phase 140) of the three-phase matrix bridge 120 while disabling the third phase (for example, third phase 150) of the three-phase matrix bridge 120. The second two-phase switching pattern may comprise switching the first phase (for example, first phase 130) and the third phase (for example, third phase 150) of the three-phase matrix bridge 120 while disabling the second phase (for example, second phase 140) of the three-phase matrix bridge 120. The third two-phase switching pattern may comprise switching the second phase (for example, second phase 140) and the third phase (for example, third phase 150) of the three-phase matrix bridge 120 while disabling the first phase (for example, first phase 130) of the three-phase matrix bridge 120.

Step 706 may include switching the three-phase matrix bridge by applying, in an alternating fashion, the selected two of the first, the second, and the third two-phase switching pattern. For example, as described above with reference to FIGS. 1 and 2, and as also illustrated in FIG. 3B, control circuit 110 may repeatedly alternate between a first two-phase switching pattern and a second two-phase switching pattern over the course of macro-period 310. Control circuit 110 may control three-phase matrix bridge 120 according to a first two-phase switching pattern (switching first phase 130 and second phase 140 while disabling third phase 150) during repeated instances of first micro-period 311. Control circuit may also control three-phase matrix bridge 120 according to a second two-phase switching pattern (switching first phase 130 and third phase 150 while disabling second phase 140) during repeated instances of second micro-period 312 that are interleaved with the repeated instances of first micro-period 311.

Step 708 may include switching an H-bridge coupled between a secondary side of the transformer and a battery. For example, as described above with reference to FIG. 4, during micro-period 311, control circuit 110 may drive first phase 130 and second phase 140 to apply Vp across the primary winding 160p, and may also drive H-bridge 170 to apply Vs across secondary winding 160s. The magnitudes and pulse-widths of the voltages applied across the primary and secondary windings of transformer 160 may induce a triangular shaped current through inductance 155 and the primary winding 160p of transformer 160 during each instance of micro-period 311. During micro-period 312, control circuit 110 may drive first phase 130 and third phase 150 to apply Vp across the primary winding 160p, and may drive H-bridge 170 to apply Vs across secondary winding 160s. The magnitudes and pulse-widths of the voltages applied across the primary and secondary windings of transformer 160 may induce a trapezoidal shaped current through inductance 155 and the primary winding 160p of transformer 160 during each instance of micro-period 312.

Step 710 may include changing which two of the first two-phase switching pattern, the second two-phase switching pattern, and the third two-phase switching pattern comprise the selected two based at least in part on a change of the first phase voltage, the second phase voltage, and the third phase voltage. For example, as described above, control circuit 110 may be configured to change which two of the first, the second, and the third two-phase switching patterns comprise the selected two based at least in part on a change of the first phase voltage (Va for example), the second phase voltage (Vb for example), and the third phase voltage (Vc for example) present at the three-phase AC voltage input 103.

In some embodiments, the phase requesting the most current for a given macro-period may be operated continuously while the other two phases are discontinuous (thereby keeping transformer RMS current low) throughout the macro-period. For example, during the macro-period 310 shown in FIGS. 3A and 3B, the first phase voltage Va may have a higher magnitude than the second phase voltage Vb and the third phase voltage Vc. To maintain a high power factor (with the respective phase currents linearly tracking the respective phase voltage), control circuit 110 may select the first and second two-phase switching patterns to alternate between during macro-period 310. Accordingly, the first phase 130 (also labeled as Phase A) may be switched throughout macro-period 310, while the second phase 140 (also labeled as Phase B) and the third phase 150 (also labeled as Phase C) are alternatively enabled and disabled during repeating instances of micro-period 311 and micro-period 312. The average of the first phase current Iₐ may thus be controlled to be higher than the respective averages of the second phase current I_{b} and the third phase current I_{c} during macro-period 310, thereby more closely corresponding to the higher phase voltage Vₐ. As the phase voltages Va, Vb, and Vc change over time, the designation of the two selected two-phase switching patterns may change depending on the respective levels of Va, Vb, and Vc so that the phase requesting the most current during a given macro-period is the phase that is operated continuously while the others are operated discontinuously.

Step 712 may include regulating a flow of power from the three-phase AC voltage input to the battery based on the switching of the three-phase matrix bridge and the switching of the H-bridge. For example, as described above with reference to FIG. 1, control circuit 110 may be configured to control switching of three-phase matrix bridge 120 and H-bridge 170 to regulate a flow of power from three-phase AC voltage input 103 to the battery 180 that is coupled to H-bridge 170. Three-phase matrix bridge 120 may be controlled to convert a low-frequency AC input from three-phase AC voltage input 103 into a high-frequency AC signal that is transmitted across transformer 160 (from the primary side to the secondary side) and rectified by the controlled switching of H-bridge 170 to provide DC power to charge battery 180.

Step 714 may include regulating a flow of power from the battery to the three-phase AC voltage input based on the switching of the three-phase matrix bridge and the switching of the H-bridge. For example, as described above with reference to FIG. 1, power converter 100 may be configured as a bi-directional power converter. Accordingly, control circuit 110 may also be configured to control switching of three-phase matrix bridge 120 and H-bridge 170 to regulate a flow of power from battery 180 to three-phase AC voltage input 103. During such operation, control circuit 110 may control the switching of H-bridge 170 to convert the DC voltage across battery 180 into a high-frequency AC signal that is transmitted across transformer 160 (from the secondary side to the primary side). During such operation, control circuit 110 may also control the switching of three-phase matrix bridge 120 to convert the high-frequency AC signal from transformer 160 into a low-frequency AC signal that may be placed back on the grid via three-phase AC voltage input 103.

Although examples have been described above, other modifications and variations may be made from this disclosure without departing from the spirit and scope of these examples. The above descriptions of various embodiments illustrate the principles of the invention. Numerous variations and modifications will become apparent to those skilled in the art based on the above disclosure. The following claims are intended to embrace all such variations and modifications.

1. A power converter comprising:
a transformer;
an H-bridge coupled between a secondary side of the transformer and a battery;
a three-phase matrix bridge coupled between a three-phase AC voltage input and a primary side of the transformer; and
a control circuit coupled to control switching of the three-phase matrix bridge and the H-bridge, the control circuit configured to alternate between a selected two of a first two-phase switching pattern, a second two-phase switching pattern, and a third two-phase switching pattern, wherein:
the first two-phase switching pattern comprises switching a first phase and a second phase of the three-phase matrix bridge;
the second two-phase switching pattern comprises switching the first phase and a third phase of the three-phase matrix bridge; and
the third two-phase switching pattern comprises switching the second phase and the third phase of the three-phase matrix bridge.

2. The power converter of claim 1, wherein:
the first two-phase switching pattern further comprises disabling the third phase of the three-phase matrix bridge;
the second two-phase switching pattern further comprises disabling the second phase of the three-phase matrix bridge; and
the third two-phase switching pattern further comprises disabling the first phase of the three-phase matrix bridge.

3. The power converter of claim 1, wherein the control circuit is configured to determine the selected two of the first two-phase switching pattern, the second two-phase switching pattern, and the third two-phase switching pattern based at least in part on a first phase voltage, a second phase voltage, and a third phase voltage at the three-phase AC voltage input.

4. The power converter of claim 3, wherein the control circuit is configured to change which two of the first, the second, and the third two-phase switching patterns comprise the selected two based at least in part on a change of the first phase voltage, the second phase voltage, and the third phase voltage at the three-phase AC voltage input.

5. The power converter of claim 1, wherein each of the first phase, the second phase, and the third phase of the three-phase matrix bridge comprises:
a first bi-directional switch coupled between a first terminal of a primary winding of the transformer and a respective one of a first, a second, and a third AC voltage input; and
a second bi-directional switch coupled between a second terminal of the primary winding of the transformer and the respective one of the first, the second, and the third AC voltage input.

6. The power converter of claim 1, wherein the H-bridge comprises:
a first switch coupled between a first terminal of a secondary winding of the transformer and a first terminal of the battery;
a second switch coupled between the first terminal of the secondary winding of the transformer and a second terminal of the battery;
a third switch coupled between a second terminal of the secondary winding of the transformer and the first terminal of the battery; and
a fourth switch coupled between the second terminal of the secondary winding of the transformer and the second terminal of the battery.

7. The power converter of claim 1, further comprising a three-phase filter coupled between the three-phase AC voltage input and the three-phase matrix bridge.

8. The power converter of claim 7, wherein the three-phase filter has a cut-off frequency lower than a frequency at which the control circuit is configured to alternate between the selected two of the first two-phase switching pattern, the second two-phase switching pattern, and the third two-phase switching pattern.

9. The power converter of claim 1, wherein the control circuit is configured to control switching of the three-phase matrix bridge and the H-bridge to regulate a flow of power from the three-phase AC voltage input to the battery.

10. The power converter of claim 1, wherein the control circuit is configured to control switching of the three-phase matrix bridge and the H-bridge to regulate a flow of power from the battery to the three-phase AC voltage input.

11. A power converter comprising:
a transformer;
an H-bridge coupled between a secondary side of the transformer and a battery;
a three-phase matrix bridge coupled between a three-phase AC voltage input and a primary side of the transformer; and
a control circuit coupled to control switching of the three-phase matrix bridge and the H-bridge, the control circuit configured to repeatedly alternate between a first two-phase switching pattern and a second two-phase switching pattern during a first macro-period, wherein:
the first two-phase switching pattern comprises switching a first phase and a second phase of the three-phase matrix bridge during a first micro-period; and
the second two-phase switching pattern comprises switching the first phase and a third phase of the three-phase matrix bridge during a second micro-period.

12. The power converter of claim 11, wherein:
the first two-phase switching pattern further comprises disabling the third phase of the three-phase matrix bridge during the first micro-period; and
the second two-phase switching pattern further comprises disabling the second phase of the three-phase matrix bridge during the second micro-period.

13. The power converter of claim 11, wherein the control circuit is configured to determine the first two-phase switching pattern and the second two-phase switching pattern based at least in part on a first phase voltage, a second phase voltage, and a third phase voltage at the three-phase AC voltage input.

14. The power converter of claim 11, wherein the control circuit is further configured to repeatedly alternate between a third two-phase switching pattern and a selected one of the first two-phase switching pattern and the second two-phase switching pattern during a second macro-period, wherein the third two-phase switching pattern comprises switching the second phase and the third phase of the three-phase matrix bridge while disabling the first phase of the three-phase matrix bridge.

15. A method of operating a three-phase matrix dual active bridge power converter, comprising:
receiving first, second, and third phase voltages at a respective first, second, and third phases of a three-phase matrix bridge coupled between a three-phase AC voltage input and a primary side of a transformer;
selecting two of a first two-phase switching pattern, a second two-phase switching pattern, and a third two-phase switching pattern based at least in part on the first phase voltage, the second phase voltage, and the third phase voltage, wherein:
the first two-phase switching pattern comprises switching a first phase and a second phase of the three-phase matrix bridge;
the second two-phase switching pattern comprises switching the first phase and the second phase of the three-phase matrix bridge; and
the third two-phase switching pattern comprises switching the second phase and the third phase of the three-phase matrix bridge;
switching the three-phase matrix bridge by applying, in an alternating fashion, the selected two of the first, the second, and the third two-phase switching pattern; and
switching an H-bridge coupled between a secondary side of the transformer and a battery.

16. The method of claim 15, wherein:
the first two-phase switching pattern further comprises disabling a third phase of the three-phase matrix bridge;
the second two-phase switching pattern further comprises disabling the second phase of the three-phase matrix bridge; and
the third two-phase switching pattern further comprises disabling the first phase of the three-phase matrix bridge.

17. The method of claim 15, further comprising changing which two of the first two-phase switching pattern, the second two-phase switching pattern, and the third two-phase switching pattern comprise the selected two based at least in part on a change of the first phase voltage, the second phase voltage, and the third phase voltage.

18. The method of claim 15, further comprising filtering a three-phase current drawn from the three-phase AC voltage input.

19. The method of claim 15, further comprising regulating a flow of power from the three-phase AC voltage input to the battery based on the switching of the three-phase matrix bridge and the switching of the H-bridge.

20. The method of claim 15, further comprising regulating a flow of power from the battery to the three-phase AC voltage input based on the switching of the three-phase matrix bridge and the switching of the H-bridge.
